(19) United States
(12) Patent Application Publication
(10) Pub. No.: US 2017/0051842 A1
(43) Pub. Date: Feb. 23, 2017

(54) Magnetic Valve System

(71) Applicant: NovaBay Pharmaceuticals, Inc., Emeryville, CA (US)

(72) Inventor: Charles Francavilla, Emeryville, CA (US)

(73) Assignee: NOVABAY PHARMACEUTICALS, INC., Emeryville, CA (US)

(21) Appl. No.: 14/831,620

(22) Filed: Aug. 20, 2015

(51) Int. Cl. F16K 31/06; F16K 1/46; G05D 7/01; F16K 1/36

(52) U.S. Cl. CPC F16K 31/0655; F16K 1/36; F16K 1/46; G05D 7/01

(57) ABSTRACT

The present invention relates generally to a magnetic valve system. Embodiments of the present invention provide a system to minimize the potential for mistakenly dispensing one fluid in place of another or desired fluid. More particularly, embodiments of the present invention provide a magnetic valve, where a bias mechanism is provided to bias the magnetic valve into a closed position, whereby a receptacle having a magnet with a magnetic polarity arranged opposite to that of the magnetic valve exerts a force on the magnetic valve sufficient to over come the bias mechanism, and the magnetic valve slides into an open position or state permitting fluid to flow into the receptacle. When the receptacle is removed, the bias mechanism forces the magnetic valve back into the closed position, where no or minimal fluid is permitted to flow.

### INCORPORATION BY REFERENCE

All publications and patent applications mentioned herein are incorporated by reference to the same extent as if each individual publication or patent application was specifically and individually indicated to be incorporated by reference.

### FIELD

The present invention relates generally to a magnetic valve system. Embodiments of the present invention provide a system to minimize the potential for mistakenly dispensing one fluid in place of another or desired fluid. More particularly embodiments of the present invention minimize or prevent dispensing of contact lens disinfecting solution, typically hydrogen peroxide, unless it is into a contact lens disinfecting case. More particularly, embodiments of the present invention provide a magnetic valve, where a bias mechanism is provided to bias the magnetic valve into a closed position. This embodiment also includes a receptacle with a magnet, where the poles of the magnet are arranged such that when the valve comes into proximity with the receptacle, the magnet exerts a force on the magnetic valve sufficient to over come the bias mechanism, and the magnetic valve slides into an open position or state permitting fluid to flow into the receptacle. When the receptacle is removed, the bias mechanism forces the magnetic valve back into the closed position, where no or minimal fluid is permitted to flow.

### BACKGROUND

A contact lens user normally has several bottles of different solutions to care for contact lenses. One is a disinfection solution, most commonly hydrogen peroxide, another a rinsing or cleaning solution used to wet and/or clean the lens, of debris for example. On occasion a user will rinse the lenses with hydrogen peroxide mistaking it for the cleaning solution, and then place the lenses back in the eyes. The result is severe discomfort from the un-neutralized hydrogen peroxide. Mechanisms, devices and methods for minimizing the risk of this mistake are not presently available in the market place. This disclosure focuses on valve systems, devices and methods to prevent accidently dispensing one fluid in place of an intended fluid.

Many examples of valve systems using magnets, and magnets in combination with ferromagnetic material to open a valve and permit fluid flow exist in the prior art. In general the prior art discloses a valve with magnetic properties (permanent magnet or magnetic material, e.g., iron) sealing a dispensing port under gravitational force. A magnetic force sufficient of unsealed position permitting fluid flow. For example, and referring to FIGS. 1A-1B, U.S. Pat. No. 3,212,539 describes a valve for dispensing a fixed volume of liquid (e.g., liquor) from an inverted bottle 10 into a fixed volume dispenser 11 attached to the inverted bottle. The fluid is dispensed into receiver 30 (e.g., cocktail jigger) while dispenser 11 seals bottle 10. Dispenser 11 has collar 12 into which and against which the neck of bottle 10 is inserted and sealed. Dispenser 11 also has elongated sleeve 13 disposed therethrough with one end of the sleeve extending and opening into bottle 10, and the other end 18 extending down into fluid chamber 17, thereby providing fluid connection between bottle 10 and chamber 17. Sphere 27 is connected to cylindrical permanent magnet 26, which is slidingly disposed in annulus 21. Under gravitational force sphere 27 seals dispensing port 25, where end 18 of elongated sleeve remains open and fluid from bottle 10 can fill chamber 17. Receiver 30 has permanent magnet 31 with a polarity opposite to that of magnet 26 in dispenser 11. Receiver 30 is brought into proximity of dispenser 11 and an opposing magnetic force, between magnets 26 and 31, overcomes gravitational force and slides magnet 26 up annulus 21, causing sphere 27 to unseal port 25 and to seal end 18 of sleeve 13. The moving of sphere 27 unseals port 25 permitting the fluid in chamber 17 to flow through slots 28 and into receiver 30, and seals end 18 of sleeve 13 preventing fluid flow from bottle 10. When receiver 30 is removed from dispenser 11, sphere 27 reseals port 25 under the gravitational force and unseals end 18, where fluid from bottle 10 refills chamber 17. Other references provide different ways of using magnets, gravity and ferromagnetic material to facilitate the sealing and unsealing of a fluid source. E.g., U.S. Pat. Nos. 3,198,404; 4,261,485; 5,505,349; 5,586,589; 5,702,032; and 8,763,655. However, these examples do not provide a valve to prevent fluid flow from a vessel (e.g. a hydrogen peroxide bottle) without the aid of gravity, or permit flow from the vessel into a specific receptacle (e.g., lens disinfection case) designed to open the valve when the receptacle and valve are brought into proximity of each other.

### SUMMARY OF THE DISCLOSURE

Embodiments of the present invention provide a valve with a valve magnet that is biased into the closed position with a biasing mechanism, where the valve magnet may be forced into the open position by another magnet, which force overcomes the bias into the closed position. For example, one embodiment includes a hollow body with a proximal end and a distal end, where the hollow body is formed by a wall having an exit port located in its distal end and a fluid entry port at its proximal end. This embodiment also includes a valve magnet, where the valve magnet is slidingly disposed in the hollow body, and where the valve magnet has a first polarity aligned with the proximal end and the distal end of the hollow body. This embodiment biases the valve magnet into the closed state, whereby a receptacle magnet brought into proximity of the exit port forces the valve magnet to slide into the open state. The biasing mechanism may be a biasing magnet with a polarity such that the biasing magnet biases the valve magnet into the closed state. There may be an annular ridge in the wall between the proximal end and the distal end of the hollow body, and the valve magnet has an o-ring that seats against the annular ridge in the closed state. Alternatively, the valve magnet may have an o-ring located at the distal end thereof, where the o-ring seats against the distal end of the hollow body in the closed state. Alternatively, the valve magnet may have a hole extending at least partially into the distal end thereof with a piece of sealing material extending out of the hole such that the sealing material seats against the distal end of the hollow body in the closed state. In an alternative embodiement, a sleeve within the hollow body may be provided where the valve magnet with the sealing material extending therefrom is slidingly disposed therein. In a further embodiment, a guide may be provided inside the hollow body, where the guide has a channel with a proximal opening below the proximal end of the hollow body and a distal opening above the exit port, where the valve magnet, preferably having a rod shape, is slidingly disposed in the channel such that the biasing magnet forces the valve magnet into the closed state where the distal end of the valve magnet seats against the exit port.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A-1B illustrate an exemplary prior art valve;

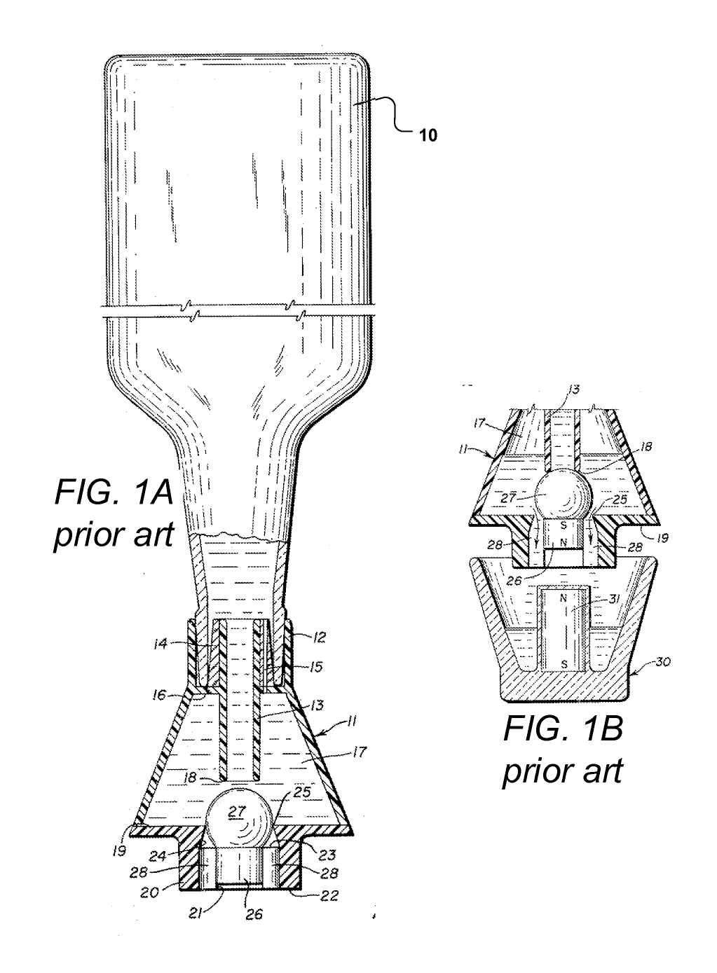

FIGS. 2A-2B depict a dispenser bottle and valve system in accordance with an embodiment of the present invention;

FIGS. 3A-3D depict a valve system in accordance with an embodiment of the present invention;

FIGS. 4A-4D depict a valve system in accordance with another embodiment of the present invention;

FIGS. 5A-5E depict a valve system in accordance with another embodiment of the present invention;

FIG. 6 depicts a valve system in accordance with another embodiment of the present invention;

FIG. 7 depicts a valve system in accordance with another embodiment of the present invention; and

FIGS. 8A-8D depict receptacles in accordance with embodiments of the present invention.

### DETAILED DESCRIPTION

Embodiments of the present invention provide a valve system having a valve member biased into the closed position to prevent fluid discharge whether upright or inverted. The valve member is opened by placing it in proximity to a magnetic field that overcomes the bias to open the valve member. The magnetic field used to open the valve is located on a receptacle purposed for receiving the fluid controlled by the valve, e.g., a lens disinfection case. Embodiments of valve systems in accordance with the present invention, therefore, do not permit dispensing a fluid, e.g., hydrogen peroxide, unless into a receptacle designed to receive that particular fluid. In this manner the present invention dramatically reduces the risk a user would accidently rinse lenses with hydrogen peroxide thinking it was only rinsing or cleaning solution.

Unless specifically noted otherwise herein, the definitions of the terms used are standard definitions used in the art. Exemplary embodiments, aspects and variations are illustrated in the figures and drawings, and it is intended that the embodiments, aspects and variations, and the figures and drawings disclosed herein are to be considered illustrative and not limiting.

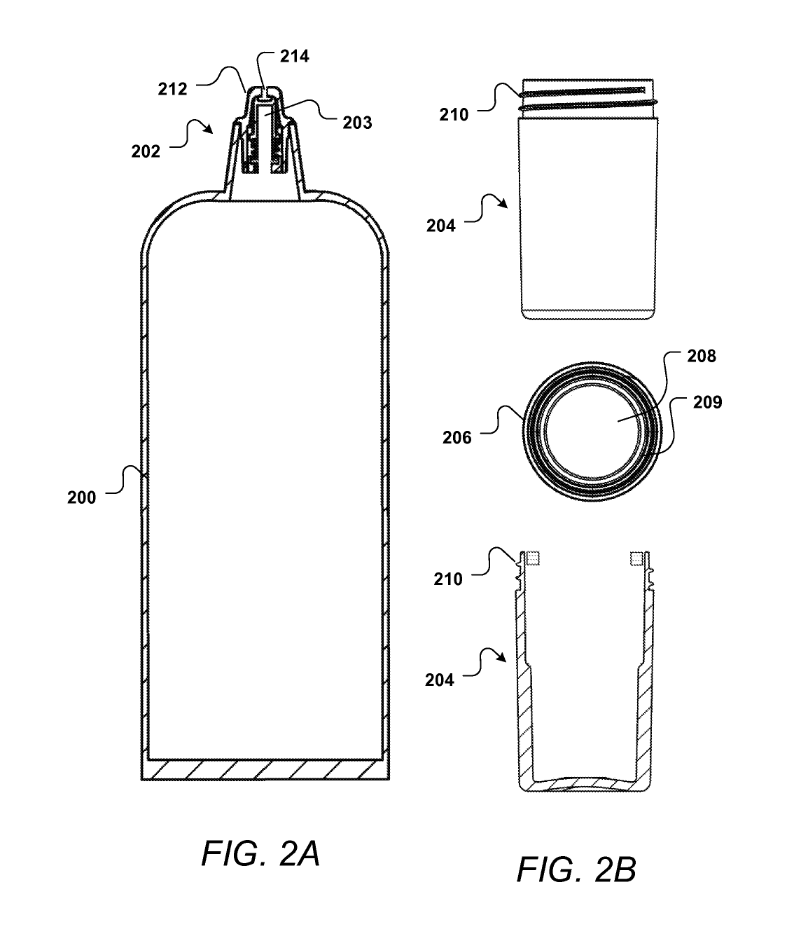

FIGS. 2A-2B depict solution bottle 200, e.g., hydrogen peroxide solution bottle, valve 202 and receptacle 204 in accordance with an embodiment of the present invention. Receptacle 204 has annular cap 206 with opening 208, and receptacle magnet 209 (described more fully below) associated with opening 208. Cap 206 detachably threads to receptacle 204 via threads 210 or is alternatively fixedly attached to receptacle 204 by any suitable means or integral therewith. Other embodiments of receptacle 204 will be more fully discussed below following the discussion of embodiments of the valve. Embodiments of valve 202 include a valve member 203 (more fully described below) biased into the closed position even when bottle 200 and valve 202 are in the upright position. A user places nipple 212 in the proximity of opening 208 and a magnetic field from receptacle magnet 209 exerts a force on and moves valve member 203 to an open position, thereby unsealing port 214 allowing a user to dispense fluid from bottle 200. When receptacle 204 is moved away from valve 202, valve member 203 is biased back into the sealed position preventing fluid flow out of port 214.

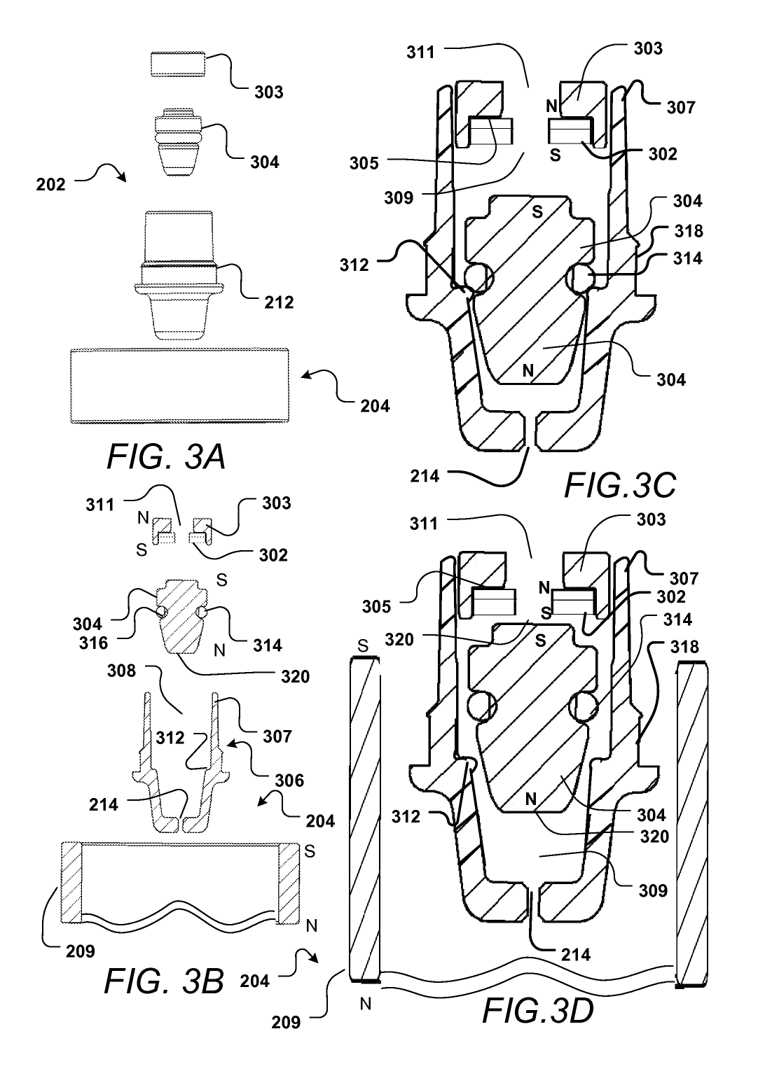

FIGS. 3A-3D depict a first embodiment of valve 202 in accordance with the present magnet 302 fixed therein, valve magnet 304 and nipple 212. Receptacle 204 in FIG. 3A and receptacle magnet 209 in FIG. 3B and FIG. 3D are shown for demonstrative purposes, but will be more thoroughly described below.

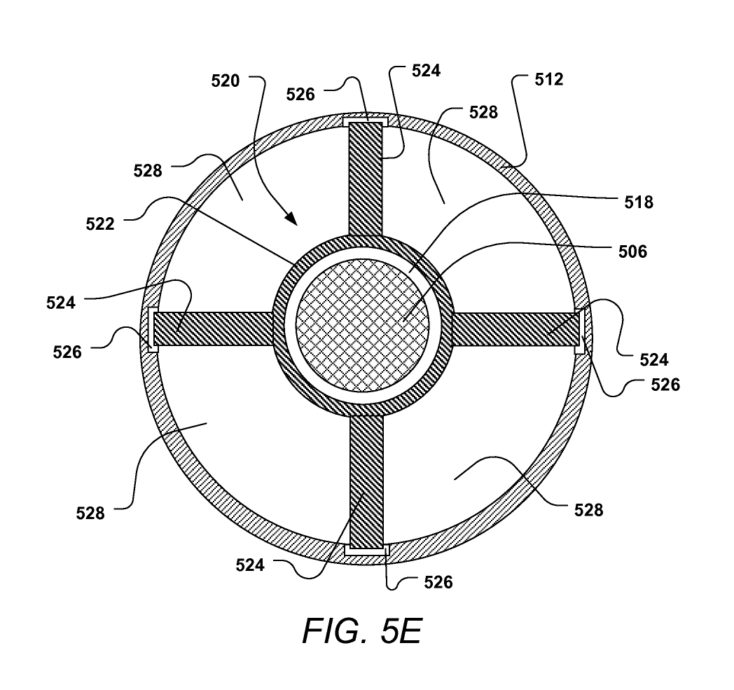

FIGS. 3B-3D are cross-sections of the embodiment shown in FIG. 3A, where FIG. 3B is in disassembled form, and FIGS. 3C and 3D are in assembled form in closed and open states, respectively. Nipple 212, having a preferred circular cross-section (not shown), has body 306 with walls 307, annular space 308 therein, port 214 at the distal end of body 306, and annular lip 312 on the interior of walls 307. Valve magnet 304 has O-ring 314 aligned in groove 316. Alternatively, O-ring 314 may be secured to distal end 320 of valve magnet 304 (see FIG. 6) Valve magnet 304 is preferably a permanent magnet with its polarity arranged opposite to that of biasing magnet 302. Valve magnet 304 in this embodiment has a conical shape with blunt distal end 320, and shaped generally to be slidingly received in annular space 308. Plug 303 is fit into the proximal end of body 307, thereby turning annular space 308 into annular cavity 309, within which valve magnet 304 may slide up and down. Plug 303 has biasing magnet 302 attached thereto, preferably on distal side 305 of plug 303. Both biasing magnet 302 and plug 303 have hole 311 going therethrough to allow fluid to flow into and through valve 202 when in the open position.

Referring to FIG. 3C the magnetic field of biasing magnet 302 interacts with the polar opposite magnetic field of valve magnet 304 forcing valve magnet 304 down, and more specifically forcing gasket 314 to seat against annular lip 312, thereby sealing valve 202 to a closed state. By virtue of this biasing mechanism valve 202 remains sealed despite its relation to gravitational force. The exterior of valve body 307 has fitting 318 to secure valve 202 into a solution bottle or a top that may be attached (e.g., by threading) to a solution bottle. Fitting 318 may be any type of fitting known to the skilled artisan for fluid tight attachment of one piece to another, for example and not by way of limitation a luer fitting, threads, pressure fitting, adhesive etc.

Referring to FIG. 3D, valve 202 is depicted assembled and in the open state. Receptacle magnet 209 or magnetic field with a polarity preferably aligned to that of valve magnet 304 applies a force to valve magnet 304 as it comes into proximity with receptacle magnet 209 that overcomes the biasing force applied by biasing magnet 302 (and gravity as the bottle will be inverted to dispense fluid), which force slides valve magnet 304 within annular cavity 309 unseating gasket 314 from annular lip 312, thereby allowing fluid to flow through hole 311, past/around valve magnet and out port 214 into receptacle 204 (not shown in FIG. 3D). The skilled artisan will appreciate that channels or other surface deformity (not shown) may be magnet 304 from sealing hole 311. The skilled artisan will also appreciate the user will squeeze the solution bottle generating pressure that will push valve magnet 304 away from biasing magnet to create the flow. In this embodiment a user could theoretically generate sufficient pressure to overcome the opening force exerted by receptacle magnet 209, but the appropriate amount of squeezing will be easily learned so as to minimize or eliminate this issue. It will be further appreciated that the polarity of receptacle magnet may be opposite to that of valve magnet 304. Aligning the polarities of the receptacle magnet with that of the valve magnet is preferred. It was found that insertion of the nipple into a receptacle with opposing magnetic field alignment did not work as well on a theory that a symmetric receptacle magnetic field had a void in the center, the natural position for a user to insert the nipple to dispense fluid. This void, in theory, did not generate the desired force unless the nipple was moved to an angle or outside the center. On the other hand, with the polarities aligned insertion of the nipple into the receptacle places the valve magnet in a position that the lower portion of the receptacle magnet will create the desired opening force. Receptacle 204 and its associated receptacle magnet 209 or magnetic field will be discussed in more detail below, following the discussion of alternative embodiments for the valve. Upon removal of receptacle magnet 209 and/or valve 202, biasing magnet 302 will force valve magnet 304 back into the seated position, thereby returning valve 202 into its closed state.

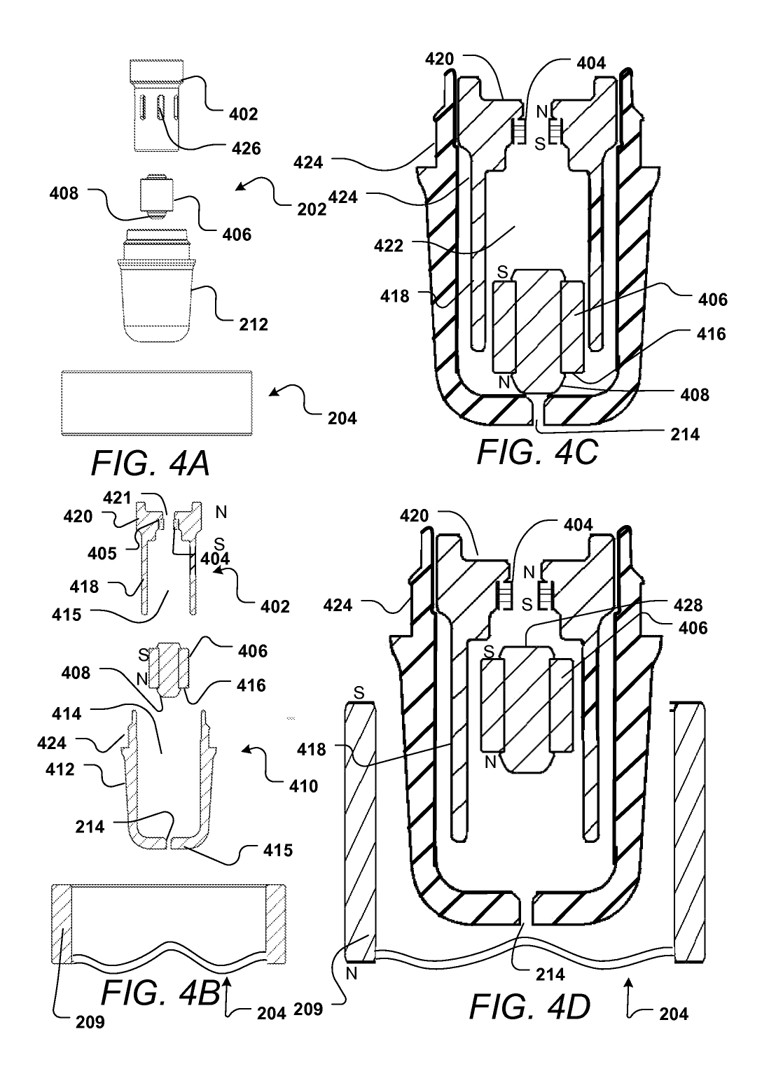

FIGS. 4A-4D depict another embodiment of the present invention. In this embodiment, valve 202 comprises sleeve 402 with biasing magnet 404 fixed therein (FIGS. 4B-4D), valve magnet 406 with seal 408 extending out therefrom, and nipple 212. Receptacle 204 in FIG. 4A and receptacle magnet 209 in FIG. 4B and FIG. 4D are shown for demonstrative purposes, but will be more thoroughly described below.

FIGS. 4B-4D are cross-sections of the embodiment shown in FIG. 4A, where FIG. 4B is in disassembled form, and FIGS. 4C and 4D are in assembled form in closed and open states, respectively. Nipple 212, having a preferred circular cross-section (not shown), has body 410 with walls 412, annular space 414 therein, and port 214 at distal end 415 of body 410. Valve magnet 406 is preferably cylindrical shape and has a hole passing therethrough with seal 408 placed therein such that at least a portion of seal 408 extends out distal end 416 of valve magnet 406. The skilled artisan will appreciate that seal 408 may pass all the way through or only lodged partially into the hole, and further that the hole need not pass all the way through valve magnet 406. Valve magnet 406 is preferably a permanent magnet with its polarity arranged opposite to that of biasing magnet 404. Valve magnet 406 in this embodiment preferably has a cylindrical shape and is shaped generally to be slidingly received in annular space 414 and pass up and seal may be used for seal 408 or any other feature of the disclosed embodiments used for creating a seal, for example and not by way of limitation, rubber or silicon.

Sleeve 402 has sides 418 extending distally from plug 420, where sides 418 form a cylinder with annular space 415. As will be appreciated the cylindrical shape of sides 418 are complementary to annular space 414, but the skilled artisan will appreciate that any complementary shapes may be selected so as to suit the purpose of forming cavity 422 in which valve magnet 406 may slide therein, as discussed more fully below.

Referring to FIGS. 4C and 4D, sides 418 are inserted into annular space 414, and plug 420 is fit into (e.g., press fit, snap fit, threaded, glued etc) the proximal end of body 410, thereby forming cavity 422, within which valve magnet 406 may slide up and down. Plug 420 has biasing magnet 404 attached thereto, preferably on distal side 405 of plug 420. Both biasing magnet 404 and plug 420 have hole 421 going therethrough to allow fluid to flow into and through valve 202 when in the open state.

Referring to FIG. 4C the magnetic field of biasing magnet 404 interacts with the polar opposite magnetic field of valve magnet 406 forcing valve magnet 406 down, and more specifically forcing seal 408 to seat against port 214, thereby sealing valve 202 to a closed state. By virtue of this biasing mechanism valve 202 remains sealed despite its relation to gravitational force. The exterior of valve body 410 has fitting 424 to secure valve 202 into a solution bottle or a top that may be attached (e.g., by threading) to a solution bottle. Fitting 424 may be any type of fitting known to the skilled artisan for fluid tight attachment of one piece to another, for example and not by way of limitation a luer fitting, threads, pressure fitting, adhesive etc.

Referring to FIG. 4D, valve 202 is depicted assembled and in the open state. Receptacle magnet 209 or magnetic field with a polarity preferably aligned with that of valve magnet 406 applies a force to valve magnet 406 that overcomes the biasing force applied by biasing magnet 404 (and gravity, as the bottle will be inverted to dispense fluid), which slides valve magnet 406 within annular cavity 422 unseating seal 408 from port 214, thereby allowing fluid to flow through hole 421, past/around valve magnet 406, and out port 214 into receptacle 204. Also provided, in preferred embodiments, are holes 426 in sides 418 that permit fluid flow between sides 418 and walls 412 when valve 202 is in the open state. The skilled artisan will appreciate that channels or other surface deformity (not shown) may be provided on or in proximal end 428 of valve magnet 406, which will assist in preventing valve magnet 406 from sealing hole 421. The skilled artisan will also appreciate the user will squeeze the solution bottle generating pressure that will push valve magnet 406 away from biasing magnet 404 to create the flow. In this embodiment a user could theoretically generate sufficient pressure to overcome the easily learned so as to minimize or eliminate this issue. Upon removal of receptacle magnet 209 and/or valve 202, biasing magnet 404 will force valve magnet 406 back into the seated position, thereby returning valve 202 into its closed state.

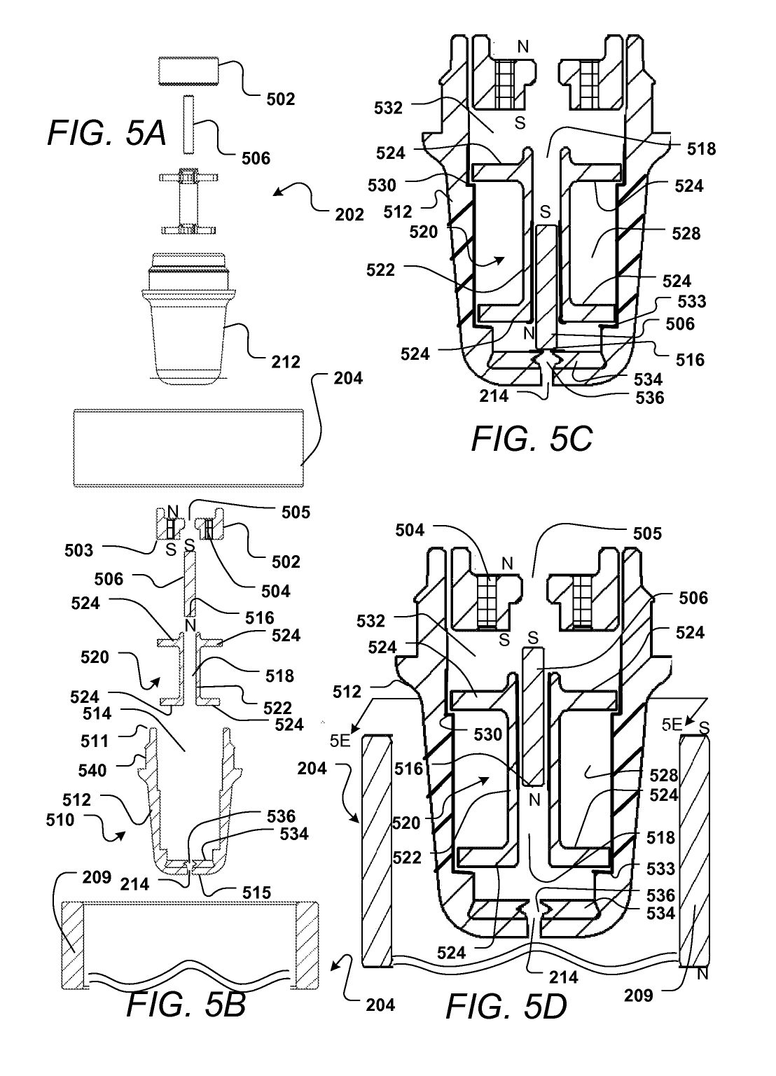

FIGS. 5A-5E depict another embodiment of the present invention. In this embodiment, valve 202 comprises plug 502 with biasing magnet 504 fixed therein (FIGS. 5B-5D), valve magnet 506, and nipple 212. Receptacle 204 and receptacle magnet 209 are shown for demonstrative purposes, but will be more thoroughly described below.

FIGS. 5B, 5C and 5D are cross-sections of the embodiment shown in FIG. 5A, where FIG. 5B is in disassembled form, and FIGS. 5C and 5D are in assembled form in closed and open states, respectively. Nipple 212, having a preferred circular cross-section (not shown), has body 510 with walls 512, annular space 514 therein, and port 214 at distal end 515 of body 510. Valve magnet 506 is preferably a cylindrical-rod shape and may be conically shaped (not shown) at its distal end 516 to aid in sealing hole 536 and port 214. Valve magnet 506 is preferably a permanent magnet with a polarity arranged opposite to that of biasing magnet 504. Valve magnet 506 in this embodiment preferably has a cylindrical-rod shape and is shaped generally to be slidingly received in channel 518 of guide member 520 and pass up and down channel 518 as described below.

Referring to FIGS. 5C-5E, particularly FIG. 5E (cross-section along line 5E of FIG. 5D) guide member 520 has sides 522 that form channel 518. Eight support arms 524 (two sets of four, upper and lower) spaced at ninety degrees around and extending at ninety degrees from sides 522 are provided at proximal and distal ends of channel 518 to support channel 518 within walls 512 of body 510. Referring to FIG. 5E, slots 526 run along the interior of walls 512 to receive and secure arms 524 within annular space 514. Arms 524 form voids 528 to allow fluid to pass through body 510 and out nipple 212 when in the open state. The skilled artisan will appreciate that as few as 2 arms may be provided to secure guide member 520, but 3 or more are preferred as providing more structural integrity. Further, upper and lower arms are preferred, though one or the other may be used, and when both used the number of arms on either do not need to be the same as shown in the depicted and described embodiment.

Referring to FIGS. 5C and 5D, guide member 520 is inserted into annular space 514, where legs 524 fit into slots 526, and valve magnet 506 is slidingly disposed in channel 518. In this embodiment annular lip 530 and 533 on the interior of walls 512 are provided as stops for arms 524 of guide member 520. Plug 502 is fit into (e.g., press fit, snap fit, threaded, glued etc) the proximal end 511 of body 510, thereby forming cavity 532, within which guide member 520 is fixed, with valve magnet 506 disposed in channel 518 of guide member 520. The skilled similar bodies described in other embodiments in this disclosure), or alternatively it may fit over the body, the only requirement being that the plug provide some sort of entry point to the valve for the fluid and that it create the cavity (e.g., 532) within the valve as described herein. Alternatively the plug may be on the distal end. Or, in another alternative the body may be in two longitudinally cut pieces that are welded, glued or otherwise adhered together. The skilled artisan will appreciate many ways to construct and assemble the embodiments of the present invention.

Plug 502 has biasing magnet 504 attached thereto, fixed thereto or associated therewith, preferably on distal side 503 of plug 502. The skilled artisan will appreciate that biasing magnet need only be associated with the plug or proximal end of the body so as to bias the valve magnet as described in this and other embodiments. Plug 502 has hole 505 going therethrough to allow fluid to flow into and through valve 202 when in the open position. As shown, biasing magnet 504 is an annular piece fit into distal side 503 of plug 502. The skilled artisan will appreciate that biasing magnet 504 can take on any number of shapes and can be placed anywhere on plug 502, or anywhere near proximal end 511 of body 510, and could be included as part of body 512. It will also be appreciated by the skilled artisan that biasing magnet 504, in all the embodiments described herein, may take on any number of shapes. Body 510 of nipple 212 has annular gasket 534 disposed inside the distal end of body 510 with hole 536 line up with port 214.

Referring to FIG. 5C the magnetic field of biasing magnet 504 interacts with the polar opposite magnetic field of valve magnet 506 forcing valve magnet 506 down, and more specifically forcing its distal end 516 into annular gasket 534 to seat against hole 536, thereby sealing valve 202 to a closed state. By virtue of this biasing mechanism valve 202 remains sealed despite its relation to gravitational force. The exterior of valve body 510 has fitting 540 to secure valve 202 into a solution bottle or into a top that may be attached (e.g., by threading) to a solution bottle. Fitting 540 may be any type of fitting known to the skilled artisan for fluid tight attachment of one piece to another, for example and not by way of limitation a luer fitting, threads, pressure fitting, adhesive etc.

Referring to FIG. 5D, valve 202 is depicted assembled and in the open state. Receptacle magnet 209 or magnetic field with poles aligned with the valve magnet 506 applies a force to valve magnet 506 that overcomes the biasing force applied by biasing magnet 504 (and gravity, as the bottle will be inverted to dispense fluid), which slides valve magnet 506 within channel 518 unseating valve magnet 506 from hole 536, thereby allowing fluid to flow through hole 505, past/around/through guide member 520, and out port 214 into receptacle 204 (not shown). The skilled artisan will appreciate that channels or other surface deformity (not shown) valve magnet 506 from sealing hole 505. In addition distal end 516 of valve magnet 506 may be conically shaped to assist in seating and sealing hold 536. Further annular gasket 534 may be provided with lip 535 around hole 536 where lip 535 deforms to assist in obtaining a better seal between valve magnet and hole 536. The skilled artisan will also appreciate the user will squeeze the solution bottle generating pressure that will push valve magnet 506 away from biasing magnet 504 to create the flow. In this embodiment a user could theoretically generate sufficient pressure to overcome the opening force exerted by receptacle magnet 209, but the appropriate amount of squeezing will be easily learned so as to minimize or eliminate this issue. In this embodiment valve magnet 506 has a smaller cross-sectional profiled than in other embodiments, making the amount of pressure required to overcome the opening force greater than in other embodiments. Upon removal of receptacle magnet 209 and/or valve 202, biasing magnet 504 will force valve magnet 506 back into the seated position, thereby returning valve 202 into its closed state.

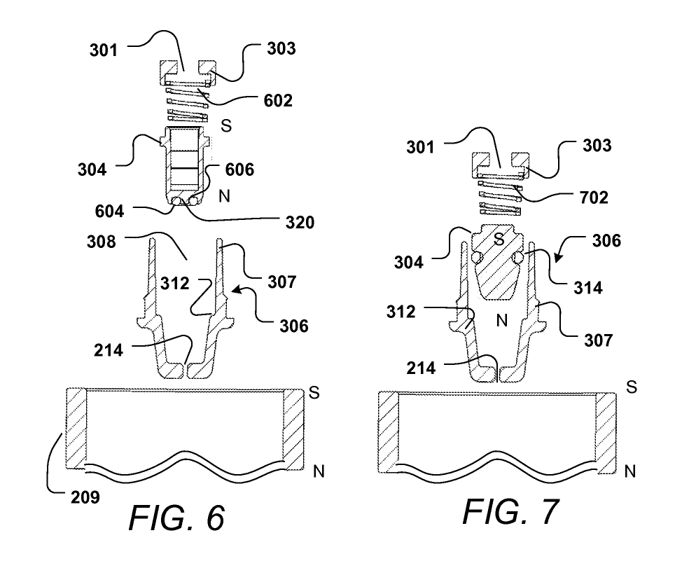

FIGS. 6 and 7 show alternative embodiments to that shown in FIG. 3. In both embodiments of FIGS. 6 and 7 the biasing magnet 302 is replaced by biasing spring 602 and 702. As the skilled will appreciate biasing spring may replace biasing magnet in any of the embodiments of the present invention. However, biasing magnet provides many distinct advantages over a spring, for example and not by way of limitation the biasing magnet does not have any moving parts and may be provided anywhere near the proximal end (e.g, inside, outside etc) as the biasing force is applied by physical or mechanical contact with the valve magnet). Further, and with reference to FIG. 6, annular gasket 314 is replaced by annular gasket 604 (e.g., o-ring) fit into groove 606 at distal end 320 of valve magnet 304. Annular gasket 604 extends beyond distal end 320 to seat against hole 214 when in the biased closed position. As will be appreciated receptacle magnet 209 or magnetic field will open valve 202 as described above.

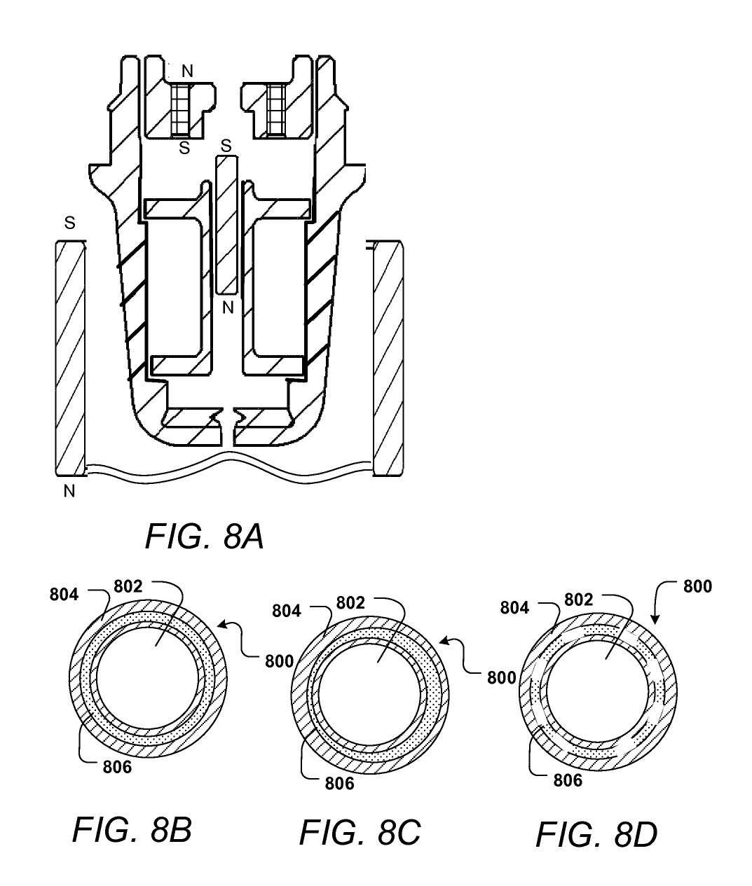

Referring to FIGS. 8A-D the skilled artisan will appreciate that any arrangement of permanent receptacle magnets or providing a magnetic field with the proper polarity (e.g., DC through coil) and magnetic strength will operate to push the magnetic valve into the open position. This will be true whether the magnets exist on the rim of receptacle, as shown in FIG. 2 and FIG. 8 or on the body of the receptacle itself. Neodymium permanent magnets are the preferred choice for the high magnetic strength per unit mass of the material, making these magnets very compact. Preferably, as described above, the polarity of the receptacle magnet is aligned with that of the valve magnet. The inventors observed that using a ring of magnets around the rim of a receptacle with a polarity opposite to that of the valve magnet may not work as well as off-setting the receptacle magnets or aligning the polarity of the receptacle magnets to magnets or the aligned magnetic field do not have a void in the field around the center of the receptacle, the natural spot for a user to dispense, and the valve can remain unexpectedly and undesirably in the closed state (though this is quickly remedied by moving the valve relative to receptacle). By using the preferred align polarities, as the nipple enters the receptacle it is believed that the opposite polarity towards the lower portion of the receptacle magnet applies the desired force to the valve magnet. This theory is illustrated in FIG. 8A. FIGS. 8B-D show a plan, top down view of cap 800 of a receptacle, with mouth 802, rim 804 and receptacle magnet 806. In FIG. 8A receptacle magnet 806 is distributed evenly around rim 804. In FIG. 8B, receptacle magnet 806 is offset or different thicknesses around rim 804, and in FIG. 8C, receptacle magnet 806 is broken in pieces around rim 804, where the breaks can be uniform or asymmetric to provide the desired magnetic field. The inventors postulate the asymmetry of the magnets, with the polarities aligned either opposite to or the same as the polarity of the valve magnet, changes the magnetic field in a way such that insertion of the nipple directly into (e.g., oriented ˜90 degrees to the receptacle opening) near or in the center of the receptacle opening results in more reliable opening of the valve, such that users may not need to adjust the height or orientation of the nipple when they want to dispense fluid from the valve.

Several embodiments of valve 202 have been presented herein. One commonality is all the embodiments have nipple 212 with a body structure that has a fitting on its exterior. This fitting in these embodiments serves to attach or secure nipple 212 and hence valve 202 either directly or indirectly to the solution bottle. This may be accomplished by any number of known mechanisms. For example, and not by way of limitation, the fitting may be threads that screw into/onto complementary female/male opening of the solution bottle. Alternatively, the fitting may be a luer fitting that is snap fit, as is well known, directly into a complementary fitting on the solution bottle. Alternatively, the fitting may attach to a complementary fitting on another member that then is secured to the solution bottle. What has been described herein are embodiments of the inventive valve, and for brevity details of well known mechanisms for securing the valve to the solution bottle have been left out. It should be noted that all the parts except the magnets can be made of any suitable material such as but not limited to injection molded plastics like polyethylene. The magnets may be neodymium or any other desired magnetic material, and may be coated with a material that, for example, may be easily sterilized. Further, the parts for the embodiments described herein may be designed to be assembled in any manner desired, for example the bodies described in multiple embodiments herein may be split along a line parallel with the distal and proximal ends and assembled by adhering or fusing the pieces together along with the other parts therein. While a number of exemplary embodiments, modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

What is claimed is:

1. A magnetic valve comprising:
a hollow body with a proximal end and a distal end, wherein the hollow body is formed by a wall having an exit port located in the distal end of the hollow body and a fluid entry port at the proximal end of the hollow body;
a valve magnet with a proximal end and a distal end, wherein the valve magnet is slidingly disposed in the hollow body and has an open state and a closed state, and wherein the valve magnet has a first polarity aligned with the proximal end and the distal end of the hollow body;
a biasing mechanism located at the proximal end of the hollow body, wherein the biasing mechanism biases the valve magnet into the closed state preventing fluid flow from the exit port, whereby a receptacle magnet with a second polarity brought into proximity of the exit port forces the valve magnet to slide into the open state.

2. The magnetic valve according to claim 1, wherein the biasing mechanism is a biasing magnet, wherein the biasing magnet has a biasing polarity such that the biasing magnet biases the valve magnet into the closed state.

3. The magnetic valve according to claim 2, wherein the wall has an annular ridge between the proximal end and the distal end of the hollow body;
wherein, the valve magnet has an o-ring thereon located between the proximal end and the distal end of the valve magnet; and
wherein the o-ring seats against the annular ridge in the closed state preventing fluid flow from the exit port.

4. The magnetic valve according to claim 2, wherein the valve magnet has an o-ring located at the distal end of the valve magnet, and wherein the o-ring seats against the distal end of the hollow body in the closed state preventing fluid flow from the exit port.

5. The magnetic valve according to claim 2, wherein the valve magnet has a hole extending at least partially into the distal end of the valve magnet, wherein the valve magnet has a piece of sealing material extending out of the hole such that at least a portion of the piece of sealing material seats against the distal end of the hollow body in the closed state preventing fluid flow from the exit port.

6. The magnetic valve according to claim 5 further comprising:
a sleeve extending down from the proximal end of the hollow body, wherein the valve magnet is slidingly disposed in the sleeve.

7. The magnetic valve according to claim 2 further comprising:
a guide inside the hollow body, wherein the guide comprises:
a channel with a proximal opening below the proximal end of the hollow body and a distal opening above the exit port;
at least one set of at least two arms coplanar to each other and extending outwardly from the channel and into a corresponding slot in the wall of the body;
wherein, the valve magnet is slidingly disposed in the channel such that the biasing magnet forces the valve magnet into the closed state where the distal end of the valve magnet seats against the exit port.

8. The magnetic valve according to claim 7, wherein the valve magnet has cylindrical rod shape.

9. The magnetic valve according to claim 8 further comprising a gasket located at the distal end of the hollow body, the gasket having an aperture therethrough aligned with the exit port, wherein the biasing magnet forces the valve magnet into the closed state where the distal end of the valve magnet seats against the aperture of the gasket.

10. The magnetic valve according to claim 7, wherein the at least one set of at least two arms coplanar to each other and extending outwardly from the channel and into the corresponding slot in the wall of the body comprises:
a first set of at least two arms coplanar to each other and extending outwardly from the channel and into the corresponding slot in the wall of the body; and
a second set of at least two arms coplanar to each other and extending outwardly from the channel and into the corresponding slot in the wall of the body, wherein the second set is distally located relative to the first set.

11. The magnetic valve according to claim 1 further comprising:
a plug disposed in the proximal end of the hollow body, wherein the fluid entry port is located through the plug, and wherein the biasing mechanism is located on a distal side of the plug.

12. The magnetic valve according to claim 11, wherein the biasing mechanism is a spring.

13. The magnetic valve according to claim 11, wherein the biasing mechanism is a permanent magnet.

14. A valve system for permitting dispensing of a fluid only into a receptacle designed to receive the fluid, the valve system comprising:
a hollow body with a proximal end and a distal end, wherein the hollow body is formed by a wall having an exit port located in the distal end of the hollow body and a fluid entry port at the proximal end of the hollow body;
a valve magnet with a proximal end and a distal end, wherein the valve magnet is slidingly disposed in the hollow body and has an open state and a closed state, and wherein the valve magnet has a first polarity aligned with the proximal end and the distal end of the hollow body;
a biasing mechanism located at the proximal end of the hollow body, wherein the biasing mechanism biases the valve magnet into the closed state preventing fluid flow from the exit port;
a receptacle having an opening to receive fluid from the valve, the receptacle having a receptacle magnet with a second polarity associated with the opening, whereby when the valve magnet comes into proximity of the receptacle the receptacle magnet forces valve magnet to slide into the open state.

15. The valve system according to claim 14, wherein the biasing mechanism is a biasing magnet, wherein the biasing magnet has a biasing polarity opposite to that of the valve magnet such that the biasing magnet biases the valve magnet into the closed state.

16. The valve system according to claim 14 wherein the second polarity of the receptacle magnet is oriented opposite to that of the first polarity of the valve magnet.

17. The valve system according to claim 14, wherein the second polarity of the receptacle magnet is oriented aligned to that of the first polarity of the valve magnet.

18. The valve system according to claim 15, wherein the wall has an annular ridge between the proximal end and the distal end of the hollow body;
wherein, the valve magnet has an o-ring thereon located between the proximal end and the distal end of the valve magnet; and
wherein the o-ring seats against the annular ridge in the closed state preventing fluid flow from the exit port.

19. The valve system according to claim 15, wherein the valve magnet has an o-ring located at the distal end of the valve magnet, and wherein the o-ring seats against the distal end of the hollow body in the closed state preventing fluid flow from the exit port.

20. The valve system according to claim 15, wherein the valve magnet has a hole extending at least partially into the distal end of the valve magnet, wherein the valve magnet has a piece of sealing material extending out of the hole such that at least a portion of the piece of sealing material seats against the distal end of the hollow body in the closed state preventing fluid flow from the exit port.

21. The valve system according to claim 20 further comprising:
a sleeve extending down from the proximal end of the hollow body, wherein the valve magnet is slidingly disposed in the sleeve.

22. The valve system according to claim 15 further comprising:
a guide inside the hollow body, wherein the guide comprises:
a channel with a proximal opening below the proximal end of the hollow body and a distal opening above the exit port;
at least one set of at least two arms coplanar to each other and extending outwardly from the channel and into a corresponding slot in the wall of the body;
wherein, the valve magnet is slidingly disposed in the channel such that the biasing magnet forces the valve magnet into the closed state where the distal end of the valve magnet seats against the exit port.

23. The valve system according to claim 22, wherein the valve magnet has cylindrical rod shape.

24. The valve system according to claim 23 further comprising a gasket located at the distal end of the hollow body, the gasket having an aperture therethrough aligned with the exit port, wherein the biasing magnet forces the valve magnet into the closed state where the distal end of the valve magnet seats against the aperture of the gasket.

25. The valve system according to claim 22, wherein the at least one set of at least two arms coplanar to each other and extending outwardly from the channel and into the corresponding slot in the wall of the body comprises:
a first set of at least two arms coplanar to each other and extending outwardly from the channel and into the corresponding slot in the wall of the body; and
a second set of at least two arms coplanar to each other and extending outwardly from the channel and into the corresponding slot in the wall of the body, wherein the second set is distally located relative to the first set.

26. The valve system according to claim 14, wherein the receptacle magnet is a plurality of magnets distributed symmetrically around the opening.

27. The valve system according to claim 26, wherein the plurality of magnets is distributed asymmetrically around the opening.

28. The valve system according to claim 14, wherein the receptacle magnet is a single magnet distributed symmetrically around the opening.

29. The valve system according to claim 28, wherein the receptacle magnet is a single magnet distributed asymmetrically around the opening.
